(19) United States
(12) Patent Application Publication
(10) Pub. No.: US 2026/0064159 A1
(43) Pub. Date: Mar. 5, 2026

(54) WINDOW MANUFACTURING DEVICE AND WINDOW MANUFACTURING METHOD USING THE SAME

(71) Applicant: Samsung Display Co., LTD., Yongin-si (KR)

(72) Inventors: JAEBOK LEE, Yongin-si (KR); BEOMSOO KIM, Yongin-si (KR); SEUNGJUN LEE, Yongin-si (KR)

(21) Appl. No.: 19/237,845

(22) Filed: Jun. 13, 2025

(30) Foreign Application Priority Data
Sep. 4, 2024 (KR) 10-2024-0119982

(51) Int. Cl. G06F 1/16

(52) U.S. Cl. CPC G06F 1/1656; G06F 1/1616

(57) ABSTRACT

A window manufacturing method includes preparing a tank, arranging a preliminary window including a first area and a second area in the tank, arranging an upper film defining an opening on the preliminary window, preparing a control module including a first pad and a second pad, moving the control module such that the first pad and the second pad are arranged inside the opening of the upper film, providing an etchant to the tank, primarily etching the preliminary window non-contacting the first pad and the second pad, moving the control module such that first portions are exposed from the opening of the upper film, secondarily etching the preliminary window non-contacting the first pad and the second pad, and forming a window.

This application claims priority to Korean Patent Application No. 10-2024-0119982, filed on Sep. 4, 2024, and all the benefits accruing therefrom under 35 U.S.C. § 119, the content of which in its entirety is herein incorporated by reference.

### BACKGROUND

### 1. Field

Embodiments of the disclosure described herein relate to a window manufacturing device and a window manufacturing method using the same. In detail, embodiments of the disclosure described herein relate to a window manufacturing device and a window manufacturing method in which an etched portion of a window has a gentle slope.

### 2. Description of the Related Art

An electronic device provides information to a user by displaying various images on a display screen. Generally, the electronic device displays the information inside an allocated screen. Recently, flexible electronic devices including foldable flexible display panels are being developed. Unlike rigid electronic devices, the flexible electronic devices may be folded or rolled. The flexible electronic devices having variously changed shapes may be carried without being restricted by a screen size according to the related art, thereby improving user convenience.

The electronic device includes a display panel and a window that is disposed on the display panel and protects the display panel.

### SUMMARY

Embodiments of the disclosure provide a window manufacturing device in which an etched portion of a window has a gentle slope.

Embodiments of the disclosure also provide a window manufacturing method in which an etched portion of a window has a gentle slope.

In an embodiment of the disclosure, a window manufacturing method includes preparing a tank having a concave groove, arranging a preliminary window including a first area and a second area next (adjacent) to the first area with the first area interposed therebetween in the concave groove of the tank, arranging an upper film defining an opening overlapping the first area of the preliminary window on the preliminary window, preparing a control module including a pad attaching part to which a first pad and a second pad spaced apart from the first pad are coupled, moving the control module such that the first pad and the second pad are arranged inside the opening of the upper film, providing an etchant to the concave groove of the tank, primarily etching the preliminary window non-contacting the first pad and the second pad, moving the control module in a direction away from the preliminary window such that first portions of the first pad and the second pad are exposed from the opening of the upper film, secondarily etching the preliminary window non-contacting the first pad and the second pad, and forming a window from the preliminary window.

In an embodiment, the providing the etchant to the concave groove of the tank may include brining the first pad, the second pad, and the pad attaching part into contact with the etchant.

In an embodiment, the moving the control module such that the first pad and the second pad are arranged inside the opening of the upper film may include brining the first pad and the second pad into contact with the preliminary window.

In an embodiment, the moving the control module such that the first pad and the second pad are arranged inside the opening of the upper film may include moving the control module such that the first pad and the second pad cover a distal end of the upper film, which defines the opening.

In an embodiment, a first side surface of the first pad and a second side surface of the second pad may face each other, and a distance between the first side surface and the second side surface is constant or decreased in a thickness direction of the preliminary window.

In an embodiment, the primary etching the preliminary window non-contacting the first pad and the second pad may include forming a (1-1)^{th} inner side surface next (adjacent) to the first pad, a (2-1) inner side surface next (adjacent) to the second pad, and a first lower surface extending to the (1-1)^{th} inner side surface and the (2-1)^{th} inner side surface.

In an embodiment, the secondarily etching the preliminary window non-contacting the first pad and the second pad may include forming a (1-2)^{th} inner side surface next (adjacent) to the first pad, a (2-2)^{th} inner side surface next (adjacent) to the second pad, and a second lower surface extending to the (1-2)^{th} inner side surface and the (2-2)^{th} inner side surface.

In an embodiment, a first width that is a maximum distance between the (1-1)^{th} inner side surface and the (2-1)^{th} inner side surface may be smaller than a second width that is a maximum distance between the (1-2)^{th} inner side surface and the (2-2)^{th} inner side surface.

In an embodiment, a first depth that is a distance from an upper surface to the first lower surface of the preliminary window may be smaller than a second depth that is a distance from the upper surface to the second lower surface of the preliminary window.

In an embodiment, the moving the control module in the direction away from the preliminary window may include moving the control module in a direction away from the etchant.

In an embodiment, the moving the control module in the direction away from the preliminary window may include alternately repeating a first mode of stopping a movement of the control module and a second mode of moving the control module in the direction away from the preliminary window.

In an embodiment, the window manufacturing method may further include, after the secondarily etching the preliminary window, moving the control module in the direction away from the preliminary window such that second portions of the first pad and the second pad are exposed from the opening of the upper film, and tertiarily etching the preliminary window non-contacting the first pad and the second pad, where a volume of a second portion of the second portions is greater than a volume of a first portion of the first portions.

In an embodiment, the forming the window from the preliminary window may include forming a side surface of the window, which forms one slope with a lower surface of the window.

In an embodiment, the forming the window from the preliminary window may include forming a lower surface of the window, which forms a flat plane.

In an embodiment, the forming the window from the preliminary window may include forming a side surface and a lower surface of the window such that an angle defined between the side surface of the window and the lower surface of the window is an obtuse angle.

In an embodiment, a window manufacturing device includes a tank in which an etchant is accommodated and a preliminary window is disposed, a control module including a first pad and a second pad spaced apart from the first pad, a horizontal moving part that moves the control module in a direction parallel to a first direction or a second direction perpendicular to the first direction, and a vertical moving part that moves the control module in a direction parallel to a third direction perpendicular to the first direction and the second direction, where a first side surface of the first pad and a second side surface of the second pad face each other, and a distance between the first side surface and the second side surface is constant or decreased in the third direction.

In an embodiment, the vertical moving part may include a first mode of stopping a movement of the control module and a second mode of moving the control module in the third direction, and the first mode and the second mode may be alternately repeated.

In an embodiment, each of the first pad and the second pad may include an elastic material.

In an embodiment, a distance between the first side surface and the second side surface may be continuously decreased in the third direction.

In an embodiment, each of the first side surface and the second side surface may include a first pad portion in which a distance between the first side surface and the second side surface is decreased in the third direction and a second pad portion in which the distance between the first side surface and the second side surface is constant in the third direction.

### BRIEF DESCRIPTION OF THE DRAWINGS

The above and other embodiments, advantages and features of the disclosure will become apparent by describing in detail embodiments thereof with reference to the accompanying drawings.

FIG. 1 is a perspective view of an electronic device according to the disclosure.

FIG. 2 is a perspective view illustrating a folding state of the electronic device according to the disclosure.

FIG. 3 is an exploded perspective view of the electronic device according to the disclosure.

FIG. 4 is a cross-sectional view of a window along line I-I′ illustrated in FIG. 3 according to the disclosure.

FIG. 5 is a perspective view illustrating a window manufacturing device according to the disclosure.

FIG. 6 is a schematic perspective view illustrating portions of a vertical moving part and a control module of the window manufacturing device according to the disclosure.

FIG. 7 is a cross-sectional view of the control module according to the disclosure.

FIG. 8 is a flowchart illustrating a window manufacturing method according to the disclosure.

FIGS. 9A to 9E are cross-sectional views illustrating some operations of the window manufacturing method according to the disclosure.

### DETAILED DESCRIPTION

In the specification, when it is mentioned that a first component (or an area, a layer, a part, or the like) is connected or coupled to a second component, this means that the first component is directly disposed in/connected to/coupled to the second component or a third component is disposed therebetween.

The same reference numerals refer to the same components. Further, in the drawings, the thickness, the ratio, and the dimension of components are exaggerated for effective description of technical contents. The wording “and/or” includes all one or more combinations that may be defined by associated components.

Although the terms “first”, “second”, etc. may be used to describe various components, the components should not be limited by the terms. The terms are only used to distinguish one component from another component. For example, without departing from the right scope of the disclosure, a first component may be referred to as a second component, and similarly, the second component may be also referred to as the first component. Singular expressions include plural expressions unless clearly otherwise indicated in the context.

Further, terms such as “below”, “under”, “above”, and “on” are used to describe the relationship between components illustrated in the drawings. The terms that are relative in concept are described based on a direction illustrated in drawings.

It will be understood that the terms “include”, “comprise”, “have”, etc. specify the presence of features, numbers, steps, operations, elements, or components, described in the specification, or any combinations thereof, and do not exclude in advance the presence or additional possibility of one or more other features, numbers, steps, operations, elements, or components or any combinations thereof.

Unless otherwise defined, all terms (including technical terms and scientific terms) used in the specification have the same meaning as commonly understood by those skilled in the art to which the disclosure belongs. Further, terms such as terms defined in the dictionaries commonly used should be interpreted as having a meaning consistent with the meaning in the context of the related technology and should not be interpreted in overly ideal or overly formal meanings unless explicitly defined herein.

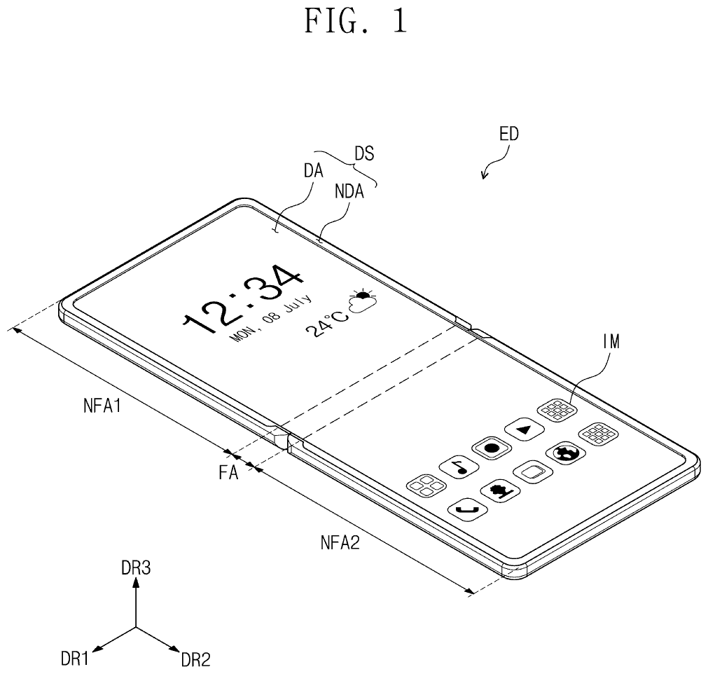

FIG. 1 is a perspective view of an electronic device ED according to the disclosure.

Referring to FIG. 1, the electronic device ED may have a quadrangular shape, e.g., rectangular shape having short sides extending in a first direction DR1 and long sides extending in a second direction DR2. However, the disclosure is not limited thereto, and the electronic device ED may have various shapes such as a circular shape and a polygonal shape. The electronic device ED may be a flexible electronic device.

The electronic device ED may include a folding area FA and a plurality of non-folding areas NFA1 and NFA2. The non-folding areas NFA1 and NFA2 may include the first non-folding area NFA1 and the second non-folding area NFA2. The folding area FA may be disposed between the first non-folding area NFA1 and the second non-folding area NFA2. The first non-folding area NFA1, the folding area FA, and the second non-folding area NFA2 may be arranged in the second direction DR2.

Exemplarily, the one folding area FA and the two non-folding areas NFA1 and NFA2 are illustrated, but the numbers of the folding area FA and the non-folding areas NFA1 and NFA2 are not limited thereto. In an embodiment, the electronic device ED may include more than two non-folding areas and a plurality of folding areas arranged between the non-folding areas, for example.

An upper surface of the electronic device ED may be defined as a display surface DS and may have a plane defined by the first direction DR1 and the second direction DR2. Images IM generated by the electronic device ED may be provided to a user through the display surface DS.

The display surface DS may include a display area DA and a non-display area NDA around the display area DA. The display area DA displays an image, and the non-display area NDA does not display the image. The non-display area NDA may surround the display area DA and may define an edge of the electronic device ED printed in a predetermined color.

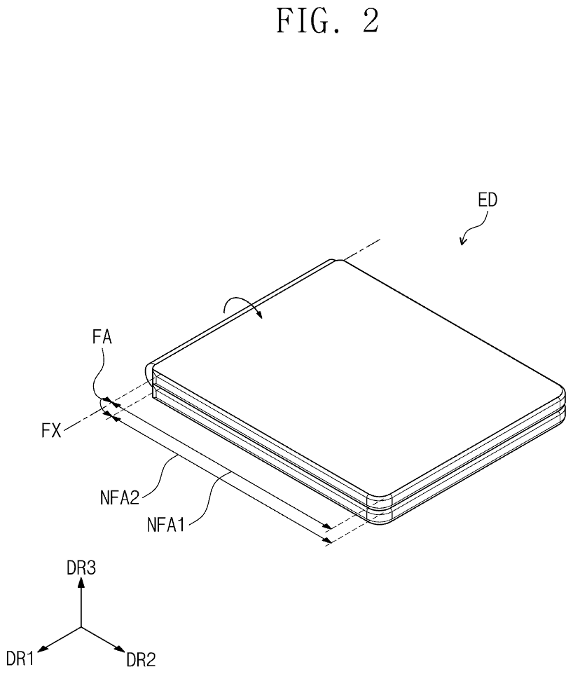

FIG. 2 is a perspective view illustrating a folding state of the electronic device ED according to the disclosure.

Referring to FIG. 2, the electronic device ED may be a foldable electronic device ED that is folded or unfolded. In an embodiment, the folding area FA may be bent with respect to a folding axis FX parallel to the first direction DR1, and thus the electronic device ED may be folded, for example. The folding axis FX may be defined as an axis parallel to the short sides of the electronic device ED.

When the electronic device ED is folded, the first non-folding area NFA1 and the second non-folding area NFA2 may face each other, and the electronic device ED may be in-folded so that the display surface DS (refer to FIG. 1) is not exposed to the outside. However, the disclosure is not limited thereto. In an embodiment, the electronic device ED may be out-folded so that the display surface DS (refer to FIG. 1) is exposed to the outside about the folding axis FX, for example.

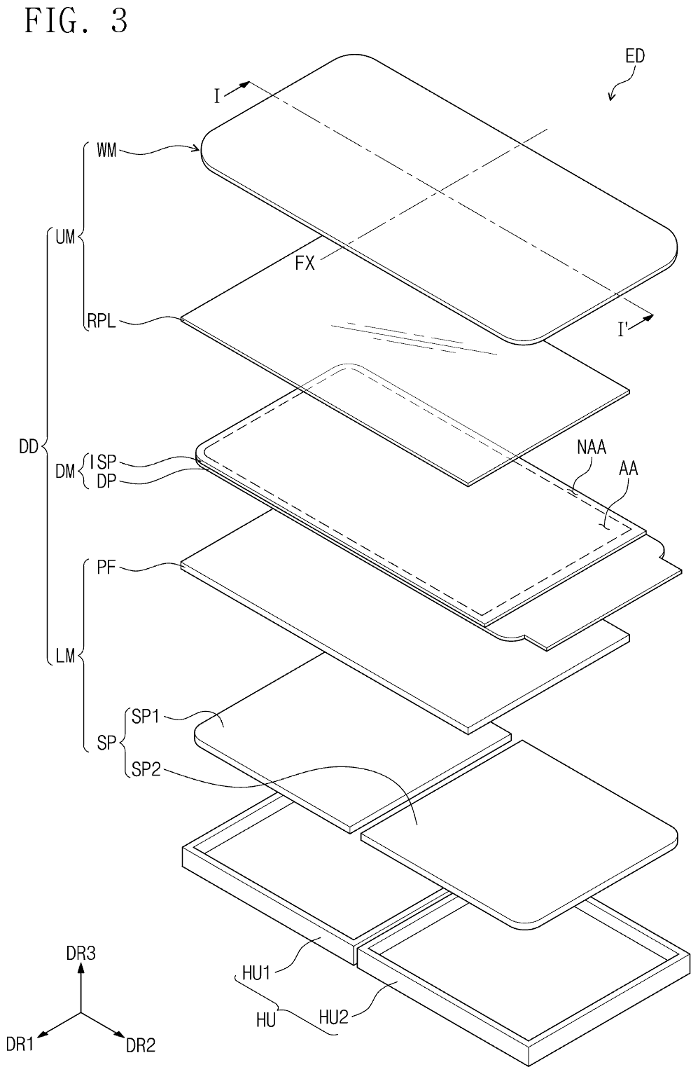

FIG. 3 is an exploded perspective view of the electronic device ED according to the disclosure.

Referring to FIG. 3, the electronic device ED may include a display device DD and a housing HU. Although not illustrated, the electronic device ED may further include a mechanical structure for controlling a folding operation of the display device DD.

The display device DD in an embodiment of the disclosure may include a display module DM that displays an image, an upper module UM disposed on the display module DM, and a lower module LM disposed under the display module DM.

The upper module UM may include a window WM disposed on the display module DM. The window WM may include an optically transparent insulating material. Accordingly, the image generated by the display module DM may be easily recognized by the user while passing through the window WM.

The upper module UM may further include one or more functional layers arranged between the display module DM and the window WM. In an embodiment of the disclosure, the functional layer may be a reflection preventing layer RPL that blocks reflection of an external light.

The reflection preventing layer RPL may prevent elements constituting the display module DM from being visually recognized from the outside by an external light incident through a front surface of the display device DD. The reflection preventing layer RPL may include a retarder and a polarizer. The retarder may be of a film type or a liquid crystal coating type and may include a λ/2 retarder and/or a λ/4 retarder. The polarizer may also be of a film type or a liquid crystal coating type. The film type may include a stretchable synthetic resin film, and the liquid crystal coating type may include liquid crystals arranged in a predetermined form. The retarder and the polarizer may implement one polarization film. The functional layer may further include a protective film disposed on or under the reflection preventing layer RPL.

The display module DM may constitute a portion of the display device DD, and in particular, the image may be generated by the display module DM. The display module DM may display an image according to an electrical signal and transmit/receive information on an external input. The display module DM may be defined as an active area AA and a peripheral area NAA. The active area AA may be defined as an area that emits the image provided from the display module DM.

The peripheral area NAA may be next (adjacent) to the active area AA. In an embodiment, the peripheral area NAA may surround the active area AA, for example. However, this is illustrated, the peripheral area NAA may be defined in various shapes, and the disclosure is not limited to an embodiment. In an embodiment, the active area AA of the display module DM may overlap at least a portion of the display area DA of FIG. 1.

The display module DM may include a display panel DP and an input sensing unit ISP. The display panel DP in an embodiment of the disclosure may be a light-emitting display panel, but the disclosure is not limited thereto. In an embodiment, the display panel DP may be an organic light-emitting display panel, an inorganic light-emitting display panel, or a quantum dot light-emitting display panel, for example. A light emission layer of the organic light emission display panel may include an organic light emission material, and a light emission layer of the inorganic light emission display panel may include an inorganic light emission material. A light emission layer of the quantum dot light-emitting display panel may include a quantum dot, a quantum rod, or the like. Hereinafter, the display panel DP may be described as the organic light-emitting display panel.

The display panel DP may generate an image. The display panel DP may be a flexible display panel. Accordingly, the display panel DP may be entirely rolled or folded or unfolded about the folding axis FX.

The input sensing unit ISP may obtain coordinate information on a user's input (e.g., a touch event). The input sensing unit ISP may be directly disposed on the display panel DP. In an embodiment of the disclosure, the input sensing unit ISP may be formed on the display panel DP by a continuous process. That is, when the input sensing unit ISP is directly disposed on the display panel DP, an adhesive film may not be disposed between the input sensing unit ISP and the display panel DP. However, the disclosure is not limited thereto. An adhesive film may be disposed between the input sensing unit ISP and the display panel DP. In this case, the input sensing unit ISP is not manufactured by a continuous process together with the display panel DP, but may be manufactured through a separate process from the display panel DP and then fixed to an upper surface of the display panel DP by an adhesive film.

The lower module LM may include a support plate SP disposed on a rear surface of the display module DM to support the display module DM and a protective film PF disposed between the display module DM and the support plate SP. The support plate SP may include support plates of which the number corresponds to the non-folding areas NFA1 and NFA2 (refer to FIG. 1). In an embodiment of the disclosure, the support plate SP may include a first support plate SP1 and a second support plate SP2 spaced apart from the first support plate SP1.

The first support plate SP1 and the second support plate SP2 may be arranged to correspond to the first non-folding area NFA1 and the second non-folding area NFA2, respectively. The first support plate SP1 may be disposed to overlap the first non-folding area NFA1, and the second support plate SP2 may be disposed to overlap the second non-folding area NFA2 of the display module DM. Each of the first support plate SP1 and the second support plate SP2 may include a metal material or a plastic material.

When the electronic device ED is in an unfolded state as illustrated in FIG. 1, the first support plate SP1 and the second support plate SP2 may be spaced apart from each other in the second direction DR2. When the electronic device ED is in a folding state with respect to the folding axis FX as illustrated in FIG. 2, the first support plate SP1 and the second support plate SP2 may be spaced apart from each other in a third direction DR3.

The first support plate SP1 and the second support plate SP2 may be spaced apart from each other to correspond to the folding area FA (refer to FIG. 1). The first support plate SP1 and the second support plate SP2 may partially overlap the folding area FA. That is, a separation distance between the first support plate SP1 and the second support plate SP2 in the second direction DR2 may be smaller than a width of the folding area FA (refer to FIG. 1).

Although not illustrated, the support plate SP may further include a connection module for connecting the first support plate SP1 and the second support plate SP2. The connection module may include a hinge module or a multi-joint module.

A case in which the support plate SP includes the two support plates SP1 and SP2 is illustrated, but the disclosure is not limited thereto. That is, when a plurality of folding axes FX are provided, the support plate SP may include a plurality of support plates separated based on the plurality of folding axes FX. Further, the support plate SP may be provided in an integral shape without being separated into the first support plate SP1 and the second support plate SP2. In this case, a bending portion may be provided on the support plate SP to correspond to the folding area FA. An opening defined to pass through the support plate SP may be provided in the bending portion or a groove recessed from one surface of the support plate SP may be provided in the bending portion.

The protective film PF may be disposed between the display module DM and the support plate SP. The protective film PF may be disposed under the display module DM to protect the rear surface of the display module DM. The protective film PF may include a synthetic resin film and may be a polyimide film or a polyethylene terephthalate film, for example. However, this is merely one of embodiments, and the protective film PF is not limited to the above example.

The housing HU may be coupled to the display device DD, particularly, the window WM, to accommodate the display module DM and the lower module LM. It is illustrated that the housing HU includes a first housing HU1 and a second housing HU2 separated from each other, but the disclosure is not limited thereto. Although not illustrated, the electronic device ED may further include a hinge structure for connecting the first housing HU1 and the second housing HU2.

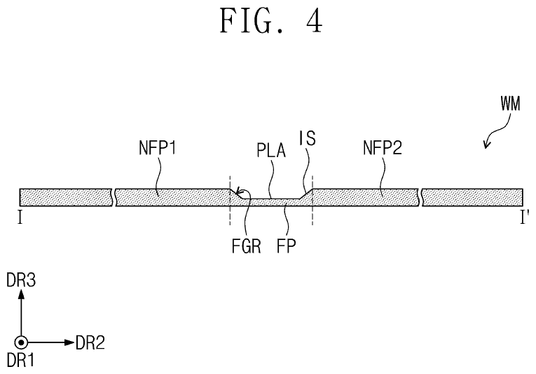

FIG. 4 is a cross-sectional view of the window WM along line I-I′ illustrated in FIG. 3 according to the disclosure.

Referring to FIG. 4, the window WM may include a first non-folding part NFP1, a second non-folding part NFP2, and a folding part FP. The folding part FP may be disposed between the first non-folding part NFP1 and the second non-folding part NFP2. The first non-folding part NFP1, the folding part FP, and the second non-folding part NFP2 may be arranged in the second direction DR2.

The first non-folding part NFP1 may overlap the first non-folding area NFA1 of FIG. 1. The second non-folding part NFP2 may overlap the second non-folding area NFA2 of FIG. 1. The folding part FP may overlap the folding area FA of FIG. 1.

A folding groove FGR may be defined on an upper surface of the folding part FP. The folding groove FGR may be formed by removing a portion from the upper surface of the folding part FP. In an embodiment, the folding groove FGR may have a shape corresponding to a portion of a trapezoid.

A thickness of the folding part FP may be smaller than a thickness of the first non-folding part NFP1 and a thickness of the second non-folding part NFP2. A height from a lower surface of the window WM to a lower surface PLA of the folding part FP may be smaller than a height from the lower surface of the window WM to an upper surface of the first non-folding part NFP1 and a height from the lower surface of the window WM to an upper surface of the second non-folding part NFP2.

As the thickness of the folding part FP is smaller than the thickness of the first non-folding part NFP1 and the thickness of the second non-folding part NFP2, when the display device DD (refer to FIG. 1) is folded, the folding part FP of the window WM may be easily folded. As the thickness of the first non-folding part NFP1 and the thickness of the second non-folding part NFP2 are greater than the thickness of the folding part FP, the first non-folding part NFP1 and the second non-folding part NFP2 may have rigidity greater than that of the folding part FP.

The folding part FP may include the lower surface PLA and side surfaces IS that define the folding groove FGR. The lower surface PLA may have a plane defined by the first direction DR1 and the second direction DR2. The side surfaces IS may extend from opposite sides of the lower surface PLA in a direction parallel to the second direction DR2 and may extend toward the upper surface of the first non-folding part NFP1 and the upper surface of the second non-folding part NFP2. When viewed from the first direction DR1, the side surfaces IS may correspond to a straight line. An angle defined between the side surfaces IS and the lower surface PLA may be an obtuse angle. Thus, a boundary between the folding part FP and the first non-folding part NFP1 and a boundary between the folding part FP and the second non-folding part NFP2 may be prevented from being visually recognized by the user.

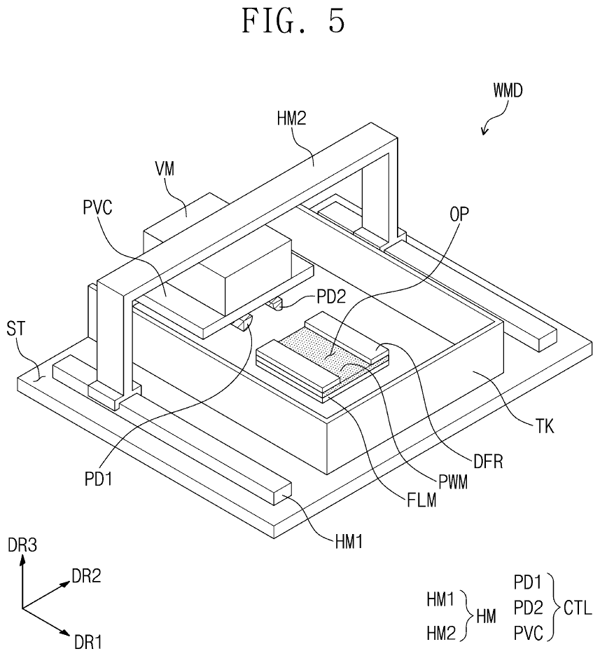

FIG. 5 is a perspective view illustrating a window manufacturing device WMD according to the disclosure.

The window manufacturing device WMD may include a stage ST, a tank TK, a control module CTL, a horizontal moving part HM, and a vertical moving part VM. The tank TK, the control module CTL, the horizontal moving part HM, and the vertical moving part VM may be arranged on the stage ST.

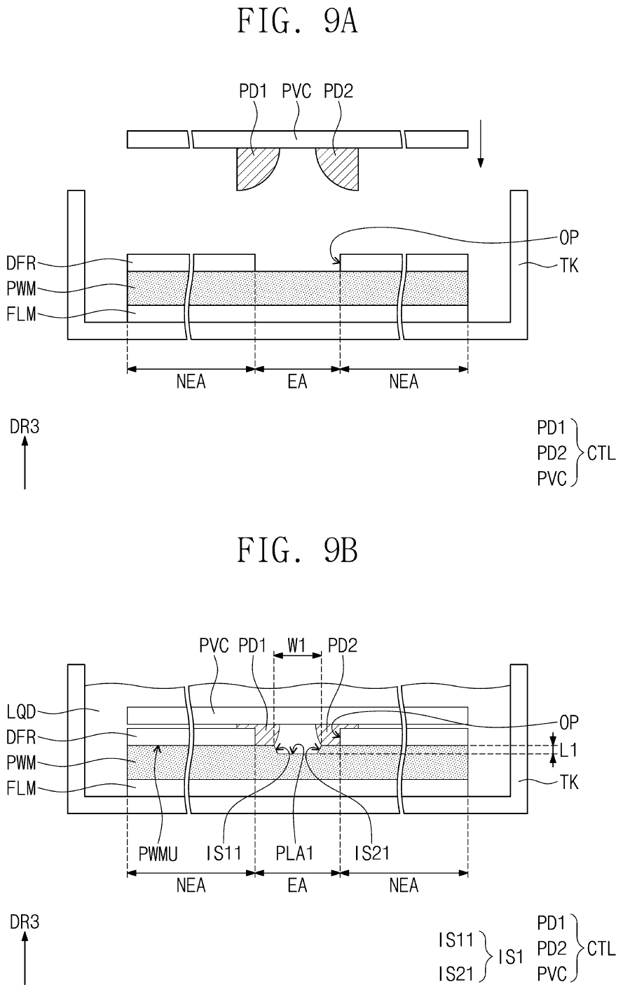

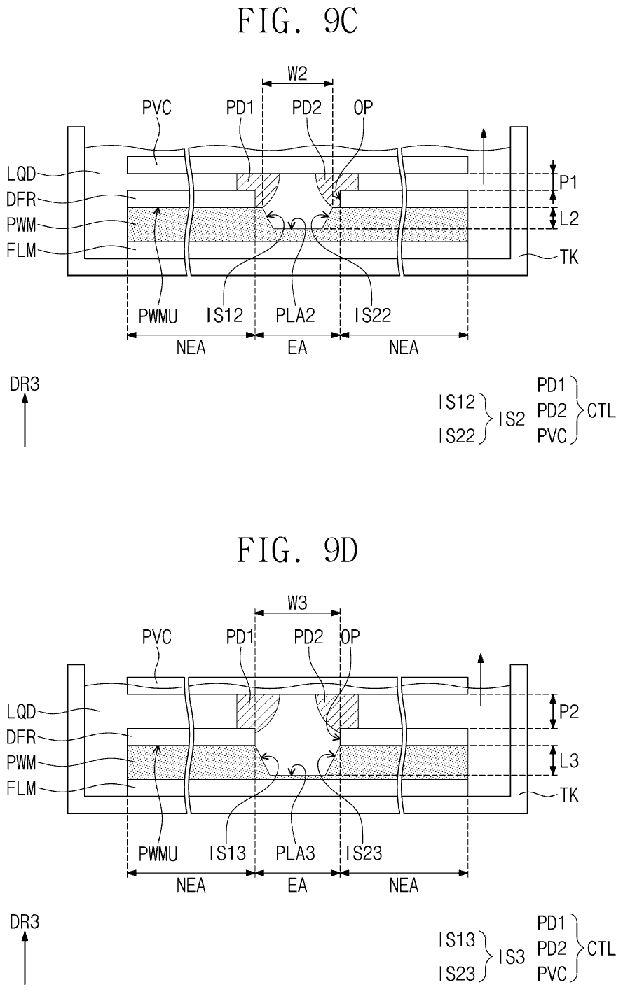

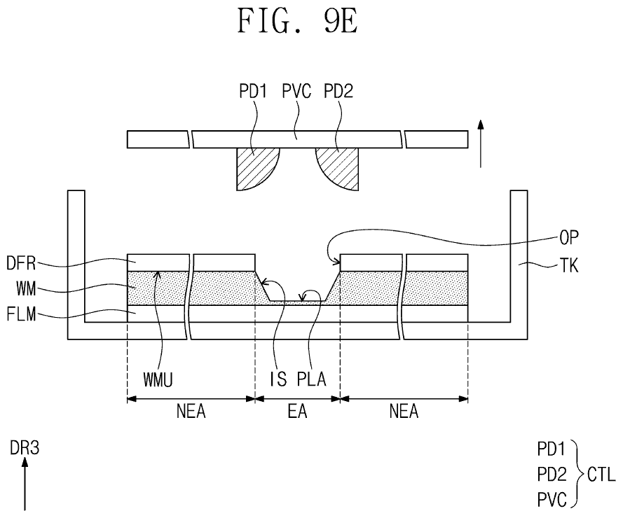

The tank TK may accommodate an etchant LQD (refer to FIG. 9B). In an embodiment, the etchant LQD may include or consist of an ammonium fluoride. The tank TK may be formed in the shape of a polyhedron. In the disclosure, it is illustrated that the tank TK has a quadrangular, e.g., rectangular parallelepiped shape having a concave groove defined by removing an upper surface thereof, but the tank TK is not limited to the above shape as long as the tank TK may accommodate the etchant LQD. A preliminary window PWM may be disposed in the concave groove of the tank TK.

The control module CTL may include a first pad PD1 and a second pad PD2. The first pad PD1 and the second pad PD2 may be spaced apart from each other in the second direction DR2. The first pad PD1 and the second pad PD2 may include an elastic material. In an embodiment, the first pad PD1 and the second pad PD2 may include or consist of silicon, for example.

The control module CTL may further include a pad attaching part PVC to which the first pad PD1 and the second pad PD2 are coupled. The pad attaching part PVC may include or consist of a material that is not etched by the etchant LQD. In an embodiment, the pad attaching part PVC may include a polyvinyl chloride. The first pad PD1 and the second pad PD2 may be coupled to a lower surface of the pad attaching part PVC, and the vertical moving part VM may be coupled to an upper surface of the pad attaching part PVC, for example. The pad attaching part PVC may support the first pad PD1 and the second pad PD2. In a process of etching the preliminary window PWM, the pad attaching part PVC, the first pad PD1, and the second pad PD2 may be etched while being immersed in the etchant LQD.

In FIG. 5, surfaces of the first pad PD1 and the second pad PD2, which are attached to a lower surface of the pad attaching part PVC, may be a curved surface. FIG. 5 illustrates a cross-sectional shape of the surface attached to the pad attaching part PVC by removing portions of the first pad PD1 and the second pad PD2. However, as long as the first pad PD1 and the second pad PD2 may be coupled to the pad attaching part PVC, the surfaces of the first pad PD1 and the second pad PD2, which are attached to the pad attaching part PVC, may have a cylindrical shape or a semi-cylindrical shape having a curved surface.

The horizontal moving part HM may move the control module CTL in a direction parallel to the first direction DR1 or the second direction DR2 perpendicular to the first direction DR1. The horizontal moving part HM may include a horizontal moving part HM1 that moves the control module CTL in the direction parallel to the first direction DR1 and a horizontal moving part HM2 that moves the control module CTL in the direction parallel to the second direction DR2. The horizontal moving part HM may be coupled to the pad attaching part PVC to move the first pad PD1 and the second pad PD2 in the direction parallel to the first direction DR1 or the second direction DR2. In an embodiment, the control module CTL may be disposed on the preliminary window PWM to be etched through the horizontal moving part HM, for example.

The vertical moving part VM may move the control module CTL in a direction parallel to the third direction DR3. In an embodiment, the vertical moving part VM may move the control module CTL in a direction closer to or away from the tank TK, for example. The control module CTL may be disposed on the preliminary window PWM to be etched through the horizontal moving part HM, and then the first pad PD1 and the second pad PD2 may be moved to contact the preliminary window PWM through the vertical moving part VM.

The vertical moving part VM may include a first mode of stopping the movement of the control module CTL and a second mode of moving the control module CTL in the direction parallel to the third direction DR3. In the process of etching the preliminary window PWM, the first pad PD1 and the second pad PD2 of the control module CTL may be repeatedly moved and stopped in the third direction DR3.

In the first mode, in a state in which the control module CTL is stopped, the preliminary window PWM may be etched in a state in which the first pad PD1 and the second pad PD2 contact the preliminary window PWM. In the second mode, the control module CTL may be moved in the third direction DR3, and thus portions (or areas) of the first pad PD1 and the second pad PD2 in contact with the preliminary window PWM may be changed. Thereafter, the first mode is repeatedly performed again, and thus the preliminary window PWM may be etched in a state in which the control module CTL is stopped. The first mode and the second mode may be alternately repeated.

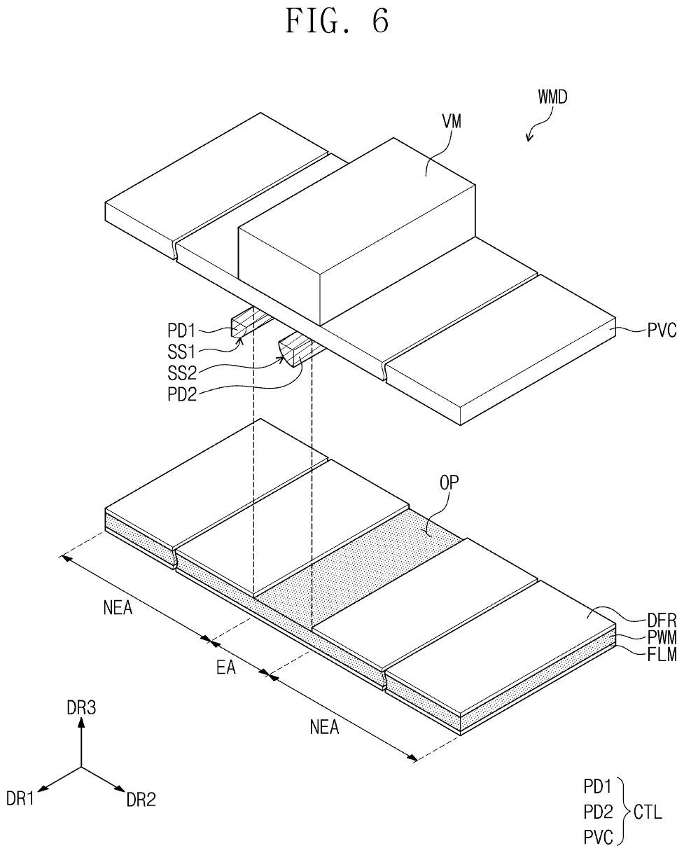

FIG. 6 is a schematic perspective view illustrating portions of the vertical moving part VM and the control module CTL of the window manufacturing device WMD according to the disclosure.

Referring to FIG. 6, a first side surface SS1 of the first pad PD1 and a second side surface SS2 of the second pad PD2 may face each other. The first pad PD1 and the second pad PD2 may have a symmetrical shape with respect to the third direction DR3. A distance between the first side surface SS1 of the first pad PD1 and the second side surface SS2 of the second pad PD2 may be constant or decreased in the third direction DR3. In an embodiment, the distance between the first side surface SS1 of the first pad PD1 and the second side surface SS2 of the second pad PD2 furthest from the pad attaching part PVC may be a maximum distance between the first side surface SS1 and the second side surface SS2, for example. Further, the distance between the first side surface SS1 of the first pad PD1 and the second side surface SS2 of the second pad PD2 closest to the pad attaching part PVC may be a minimum distance between the first side surface SS1 and the second side surface SS2.

In an embodiment, each of the first pad PD1 and the second pad PD2 may have a partial shape of a circle. In this case, the distance between the first side surface SS1 of the first pad PD1 and the second side surface SS2 of the second pad PD2 may be continuously decreased in the third direction DR3. That is, a section in which the distance between the first side surface SS1 of the first pad PD1 and the second side surface SS2 of the second pad PD2 is constant in the third direction DR3 may not be present.

The preliminary window PWM may be a component (or a member) before the window WM is processed. The window WM may be formed through the process of etching the preliminary window PWM. The preliminary window PWM may include a first area EA and second areas NEA next (adjacent) to the first area EA with the first area EA interposed therebetween. That is, the second area NEA, the first area EA, and the second area NEA of the preliminary window PWM may be arranged in one direction (e.g., the second direction DR2). The first area EA may correspond to an area in which the preliminary window PWM is etched, and the second area NEA may correspond to an area in which the preliminary window PWM is not etched. The first area EA of the preliminary window PWM may correspond to the folding part FP (refer to FIG. 4) of the window WM (refer to FIG. 4), and the second areas NEA of the preliminary window PWM may correspond to the first non-folding part NFP1 and the second non-folding part NFP2 (refer to FIG. 4) of the window WM.

An upper film DFR may be disposed on the preliminary window PWM. An opening OP may be defined in (or owned by) the upper film DFR. The opening OP of the upper film DFR may overlap the first area EA of the preliminary window PWM. That is, the opening OP of the upper film DFR may be an opening defined for the process of etching the preliminary window PWM. The upper film DFR may prevent the etchant LQD (refer to FIG. 9B) from flowing into the second area NEA. The second area NEA of the preliminary window PWM, which overlaps the upper film DFR, may not be etched. The upper film DFR may include a polymer material. In an embodiment, the upper film DFR may include polyimide or epoxy, for example. In an embodiment, the upper film DFR may include an anti-acid film.

A lower film FLM may be disposed under the preliminary window PWM. The lower film FLM may include the same material as that of the upper film DFR. The lower film FLM may prevent the etchant LQD from coming into contact with a lower surface of the preliminary window PWM.

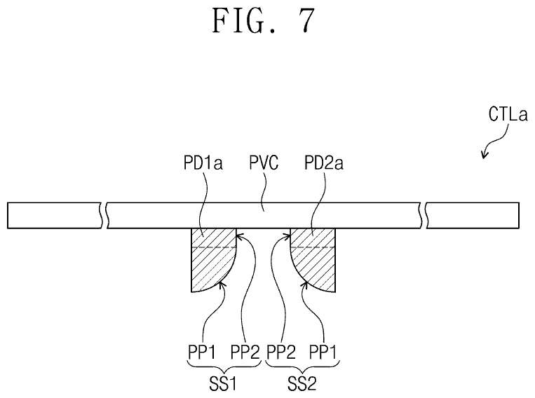

FIG. 7 is a cross-sectional view of a control module CTLa according to the disclosure.

Referring to FIG. 7, portions of a first pad PD1a and a second pad PD2a may have a circular shape, and remaining (the other) portions thereof may have a linear shape. In an embodiment, each of the first side surface SS1 of the first pad PD1a and the second side surface SS2 of the second pad PD2a may include a first pad portion PP1 in which a distance between the first side surface SS1 and the second side surface SS2 is decreased in the third direction DR3 and a second pad portion PP2 in which the distance between the first side surface SS1 and the second side surface SS2 is constant in the third direction DR3, for example. In the first pad portion PP1, the first side surface SS1 of the first pad PD1a and the second side surface SS2 of the second pad PD2a may be portions of a circle, and in the second pad portion PP2, the first side surface SS1 of the first pad PD1a and the second side surface SS2 of the second pad PD2a may be straight lines.

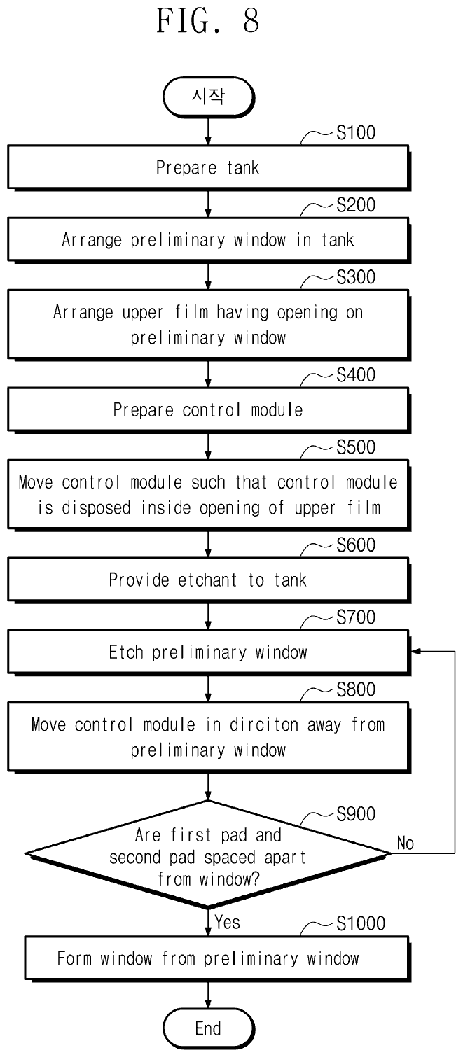

FIG. 8 is a flowchart illustrating a window manufacturing method according to the disclosure. FIGS. 9A to 9E are cross-sectional views illustrating some operations of the window manufacturing method according to the disclosure.

Referring to FIGS. 8 and 9A, a window manufacturing method may include operation S100 of preparing the tank TK. The tank TK may have a concave groove. The tank TK may be formed in the shape of a polyhedron. In the disclosure, it is illustrated that the tank TK has a cross section of quadrangular, e.g., rectangular parallelepiped shape having a concave groove defined by removing an upper surface thereof, but the tank TK is not limited to the above shape as long as the tank TK may accommodate the etchant LQD.

The window manufacturing method may include operation S200 of arranging the preliminary window PWM in the concave groove of the tank TK. In detail, the lower film FLM may be disposed inside the tank TK, and the preliminary window PWM may be disposed on the lower film FLM. The preliminary window PWM may include the first area EA and the second areas NEA next (adjacent) to the first area EA with the first area EA interposed therebetween. The first area EA may correspond to the area in which the preliminary window PWM is etched, and the second area NEA may correspond to the area in which the preliminary window PWM is not etched.

The window manufacturing method may include operation S300 of arranging the upper film DFR having the opening OP on the preliminary window PWM. The opening OP of the upper film DFR may overlap the first area EA of the preliminary window PWM. That is, the upper film DFR may cover the second area NEA of the preliminary window PWM. The upper film DFR may prevent the etchant LQD (refer to FIG. 9B) from flowing into the second area NEA. As a result, the second area NEA of the preliminary window PWM, which overlaps the upper film DFR, may not be etched, and only the first area EA of the preliminary window PWM, which overlaps the opening OP, may be etched.

The window manufacturing method may include operation S400 of preparing the control module CTL. The control module CTL may include the pad attaching part PVC to which the first pad PD1 and the second pad PD2 spaced apart from the first pad PD1 are coupled.

The first side surface SS1 of the first pad PD1 and the second side surface SS2 of the second pad PD2 may face each other. The first pad PD1 and the second pad PD2 may have a symmetrical shape with respect to the third direction DR3. The distance between the first side surface SS1 of the first pad PD1 and the second side surface SS2 of the second pad PD2 may be constant or decreased in the third direction DR3.

FIG. 9A illustrates the first pad PD1 and the second pad PD2 in which the distance between the first side surface SS1 of the first pad PD1 and the second side surface SS2 of the second pad PD2 is continuously decreased in the third direction DR3, but the disclosure is not limited to the above example. In an embodiment, portions of the first pad PD1a (refer to FIG. 7) and the second pad PD2a (refer to FIG. 7) may have a circular shape, and remaining (the other) portions thereof may have a linear shape.

Referring to FIGS. 8, 9A, and 9B, the window manufacturing method may include operation S500 of moving the control module CTL such that the control module CTL is disposed in the opening OP of the upper film DFR. The control module CTL may move in a direction opposite to the third direction DR3. In an embodiment, the control module CTL may move in a direction approaching the preliminary window PWM, for example. Operation S500 of moving the control module CTL such that the control module CTL is disposed in the opening OP of the upper film DFR may include an operation of brining the first pad PD1 and the second pad PD2 into contact with the preliminary window PWM. The first pad PD1 and the second pad PD2 may contact the preliminary window PWM inside the first area EA.

When the first pad PD1 and the second pad PD2 move in the direction opposite to the third direction DR3 after a time point when the first pad PD1 and the second pad PD2 contact the preliminary window PWM, the first pad PD1 and the second pad PD2 may be compressed. The compressed first pad PD1 and the compressed second pad PD2 may be arranged inside the opening OP of the upper film DFR.

A repulsive force may be formed in the first pad PD1 and the second pad PD2 including or consisting of an elastic material in the third direction DR3 due to a restoring elastic force during a compressing process. However, the pad attaching part PVC may be coupled to the first pad PD1 and the second pad PD2 to support the first pad PD1 and the second pad PD2, and thus the first pad PD1 and the second pad PD2 may be arranged inside the opening OP of the upper film DFR without moving. Further, operation S500 of moving the control module CTL such that the control module CTL is disposed inside the opening OP of the upper film DFR may include an operation of moving the control module such that the first pad PD1 and the second pad PD2 cover a distal end of the upper film DFR defining the opening OP. The first pad PD1 and the second pad PD2 may cover the distal end of the upper film DFR defining the opening OP, and the first pad PD1 and the second pad PD2 may contact the distal end of the upper film DFR and a portion of the preliminary window PWM.

When the first pad PD1 and the second pad PD2 cover the distal end of the upper film DFR, the etchant LQD contacts the distal end of the upper film DFR, and thus a phenomenon in which the upper film DFR and the preliminary window PWM are spaced apart from each other may be reduced or removed.

The first pad PD1 and the second pad PD2 may cover the distal end of the upper film DFR defining the opening OP Thus, even when a lifting phenomenon occurs at the distal end of the upper film DFR, as a coupling force between the upper film DFR and the preliminary window PWM is weakened, the first pad PD1 and the second pad PD2 may cover the upper film DFR to transmit a pressure to the distal end of the upper film DFR and the preliminary window PWM. With this pressure, the lifting phenomenon occurring at the distal end of the upper film DFR may be reduced or removed.

The window manufacturing method may include operation S600 of providing the etchant LQD to the concave groove of the tank TK. In an embodiment, the etchant LQD may include or consist of an ammonium fluoride. The operation of providing the etchant LQD to the concave groove of the tank TK may include an operation of brining the first pad PD1, the second pad PD2, and the pad attaching part PVC into contact with the etchant LQD. The first pad PD1, the second pad PD2, and the pad attaching part PVC may include or consist of a material that is not etched (or damaged) by the etchant LQD. In an embodiment, the first pad PD1 and the second pad PD2 may include silicon, and the pad attaching part PVC may include a polyvinyl chloride, for example.

The window manufacturing method may include operation S700 of etching the preliminary window PWM and operation S800 of moving the control module CTL in a direction away from the preliminary window PWM. After the control module CTL moves in the direction away from the preliminary window PWM, when the first pad PD1 and the second pad PD2 are not spaced apart from the window WM (S900), operation S700 of etching the preliminary window PWM and operation S800 of moving the control module CTL in the direction away from the preliminary window PWM may be repeatedly performed n times (n is a natural number of 2 or more). That is, the window manufacturing method may include an operation of primarily etching the preliminary window PWM and an operation of secondarily etching the preliminary window PWM and may further include an operation of tertiarily etching the preliminary window PWM in an embodiment. The operation of primarily etching the preliminary window PWM will be described through FIG. 9B, and the operation of secondarily etching the preliminary window PWM will be described through FIG. 9C.

First, referring to FIGS. 8 and 9B, the window manufacturing method may include operation S700 of primarily etching the preliminary window PWM that is not in contact with the first pad PD1 and the second pad PD2. The first area EA that is etched may include a portion in which the first pad PD1 and the second pad PD2 contact the preliminary window PWM and a portion in which the first pad PD1 and the second pad PD2 are not in contact with the preliminary window PWM. An area in which the first pad PD1 and the second pad PD2 contact the preliminary window PWM may be not etched because the etchant LQD is not in direct contact with the preliminary window PWM. An area in which the first pad PD1 and the second pad PD2 are not in contact with the preliminary window PWM may be etched because the etchant LQD is in direct contact with the preliminary window PWM.

In the operation of primarily etching the preliminary window PWM, side surfaces IS1 and a first lower surface PLA1 of the preliminary window PWM may be formed. In an embodiment, the operation of primarily etching the preliminary window PWM may include an operation of forming a (1-1)^{th} inner side surface IS11 next (adjacent) to the first pad PD1, a (2-1)^{th} inner side surface IS21 next (adjacent) to the second pad PD2, and the first lower surface PLA1 extending to the (1-1)^{th} inner side surface IS11 and the (2-1)^{th} inner side surface IS21, for example. A surface formed by the side surfaces IS1 and the first lower surface PLA1 formed in the preliminary window PWM and an upper surface PWMU of the preliminary window PWM may have a trapezoidal shape.

Referring to FIGS. 8 and 9C, the window manufacturing method may include operation S800 of moving the control module CTL in the direction away from the preliminary window PWM. In an embodiment, in the operation of moving the control module CTL in the direction (e.g., the third direction DR3) away from the preliminary window PWM, the control module CTL may move such that first portions P1 of the first pad PD1 and the second pad PD2 are exposed from the opening OP of the upper film DFR, for example. The operation of moving the control module CTL in the direction away from the preliminary window PWM may include an operation of moving the control module CTL away from the etchant LQD.

As the control module CTL moves in the third direction DR3, an area in which the first pad PD1 and the second pad PD2 contact the preliminary window PWM may be smaller than an area in which the first pad PD1 and the second pad PD2 contact the preliminary window PWM as illustrated in FIG. 9B. That is, the control module CTL may move in the third direction DR3, and thus an area of the preliminary window PWM non-contacting the first pad PD1 and the second pad PD2 may be widened.

Thereafter, the window manufacturing method may include operation S700 of secondarily etching the preliminary window PWM that is not in contact with the first pad PD1 and the second pad PD2. The area in which the first pad PD1 and the second pad PD2 contact the preliminary window PWM may not be etched because the etchant LQD is not in direct contact with the preliminary window PWM, and the area in which the first pad PD1 and the second pad PD2 are not in contact with the preliminary window PWM may be secondarily etched because the etchant LQD is in direct contact with the preliminary window PWM.

In the operation of secondarily etching the preliminary window PWM, side surfaces IS2 and a second lower surface PLA2 of the preliminary window PWM may be formed. In an embodiment, the operation of secondarily etching the preliminary window PWM may include an operation of forming a (1-2)^{th} inner side surface IS12 next (adjacent) to the first pad PD1, a (2-2)^{th} inner side surface IS22 next (adjacent) to the second pad PD2, and the second lower surface PLA2 extending to the (1-2)^{th} inner side surface IS12 and the (2-2)^{th} inner side surface IS22, for example. A surface formed by the side surfaces IS2 and the second lower surface PLA2 formed in the preliminary window PWM and the upper surface PWMU of the preliminary window PWM may have a trapezoidal shape.

An area in which the first pad PD1 and the second pad PD2 are not in contact with the preliminary window PWM in FIG. 9C may be larger than an area in which the first pad PD1 and the second pad PD2 are not in contact with the preliminary window PWM in FIG. 9B. That is, in the operation of secondarily etching the preliminary window PWM, an area of the preliminary window PWM in contact with the etchant LQD may increase.

A first width W1 (refer to FIG. 9B) that is a maximum distance between the (1-1)^{th} inner side surface IS11 (refer to FIG. 9B) and the (2-1)^{th} inner side surface IS21 (refer to FIG. 9B) may be smaller than a second width W2 which is a maximum distance between the (1-2)^{th} inner side surface IS12 and the (2-2)^{th} inner side surface IS22. In the operation of secondarily etching the preliminary window PWM, because the area of the preliminary window PWM in contact with the etchant LQD is increased, the etching is further performed, and thus the second width W2 may be greater than the first width W1.

A first depth L1 that is a distance from the upper surface PWMU to the first lower surface PLA1 of the preliminary window PWM may be smaller than a second depth L2 that is a distance from the upper surface PWMU to the second lower surface PLA2 of the preliminary window PWM. Because the primarily etched first lower surface PLA1 contacts the etchant LQD and is secondarily etched, the preliminary window PWM may be further etched, and accordingly, the second depth L2 may be greater than the first depth L1.

In a cross-section, an area of the trapezoid defined by the side surfaces IS2 and the second lower surface PLA2 of the secondarily etched preliminary window PWM may be greater than an area of the trapezoid defined by the side surfaces IS1 and the first lower surface PLA1 of the primarily etched preliminary window PWM.

Referring to FIGS. 8 and 9D, the window manufacturing method may further include operation S800 of moving the control module CTL in the direction away from the preliminary window PWM so that second portions P2 of the first pad PD1 and the second pad PD2 are exposed from the opening OP of the upper film DFR after operation S700 of secondarily etching the preliminary window PWM.

After the secondarily etching, volumes of the second portions P2 of the first pad PD1 and the second pad PD2, which are formed by moving the control module CTL including the first pad PD1, the second pad PD2, and the pad attaching part PVC in the third direction DR3, may be greater than volumes of the first portions P1 (refer to FIG. 9C) of the first pad PD1 and the second pad PD2. The control module CTL may move in the third direction DR3 such that the first pad PD1 and the second pad PD2 cover a portion of an upper surface of the upper film DFR. As the control module CTL moves in the third direction DR3, the first pad PD1 and the second pad PD2 may not contact the preliminary window PWM.

Thereafter, the window manufacturing method may further include operation S700 of tertiarily etching the preliminary window PWM that is not in contact with the first pad PD1 and the second pad PD2. Because the first pad PD1 and the second pad PD2 are not in contact with the preliminary window PWM, the etchant LQD may contact a front surface of the preliminary window PWM and thus the etching may be performed.

In the operation of tertiarily etching the preliminary window PWM, side surfaces IS3 and a third lower surface PLA3 of the preliminary window PWM may be formed. In an embodiment, the operation of tertiarily etching the preliminary window PWM may include an operation of forming a (1-3)^{th} inner side surface IS13 next (adjacent) to the first pad PD1, a (2-3)^{th} inner side surface IS23 next (adjacent) to the second pad PD2, and the third lower surface PLA3 extending to the (1-3) inner side surface IS13 and the (2-3)^{th} inner side surface IS23, for example. A surface formed by the side surfaces IS3 and the third lower surface PLA3 formed in the preliminary window PWM and the upper surface PWMU of the preliminary window PWM may have a trapezoidal shape.

An area in which the first pad PD1 and the second pad PD2 are not in contact with the preliminary window PWM in FIG. 9D may be larger than an area in which the first pad PD1 and the second pad PD2 are not in contact with the preliminary window PWM in FIG. 9C. That is, in the operation of tertiarily etching the preliminary window PWM, the area of the preliminary window PWM in contact with the etchant LQD may increase.

The second width W2 (refer to FIG. 9C) that is the maximum distance between the (1-2)^{th} inner side surface IS12 (refer to FIG. 9C) and the (2-2)^{th} inner side surface IS22 (refer to FIG. 9C) may be smaller than a third width W3 which is a maximum distance between the (1-3)^{th} inner side surface IS13 and the (2-3)^{th} inner side surface IS23. In the operation of tertiarily etching the preliminary window PWM, because an area of the preliminary window PWM, which contacts the etchant LQD, is increased, the etching may be further performed, and thus the third width W3 may be greater than the second width W2.

The second depth L2 (refer to FIG. 9C) that is the distance from the upper surface PWMU to the second lower surface PLA2 of the preliminary window PWM may be smaller than a third depth L3 that is a distance from the upper surface PWMU to the third lower surface PLA3 of the preliminary window PWM. Because the secondarily etched second lower surface PLA2 contacts the etchant LQD and is tertiarily etched, the preliminary window PWM may be further etched, and accordingly, the third depth L3 may be greater than the second depth L2.

In a cross-section, an area of the trapezoid defined by the side surfaces IS3 and the third lower surface PLA3 of the tertiarily etched preliminary window PWM may be greater than an area of the trapezoid defined by the side surfaces IS2 (refer to FIG. 9C) and the second lower surface PLA2 (refer to FIG. 9C) of the secondarily etched preliminary window PWM.

Referring to FIGS. 8 and 9E, the window manufacturing method may include operation S900 of spacing the first pad PD1 and the second pad PD2 apart from the window WM. When the first pad PD1 and the second pad PD2 move in the third direction DR3 and are spaced apart from the window WM, the etchant LQD may be discharged from an inside of the tank TK.

The window manufacturing method may include operation S1000 of forming the window WM from the preliminary window PWM (refer to FIG. 9D). In an embodiment of the disclosure, the primary, secondary, and tertiary etching for forming the window WM are illustrated/described, but the number of times of etching is not limited thereto. In an embodiment, the preliminary window PWM may be etched four or more times to form the window WM including the side surface IS having one slope and the flat lower surface PLA. In an embodiment, the side surface IS may be extended to the flat lower surface PLA and a flat upper surface WMU of the window WM, for example.

Operation S1000 of forming the window WM from the preliminary window PWM may include an operation of forming the side surface IS of the window WM forming one slope with the lower surface PLA of the window WM. The side surface IS of the window WM, which is formed through the etching processes of FIGS. 9A to 9D, may have one slope. A portion parallel to the lower surface PLA of the window WM may not be on the side surface IS of the window WM. The side surface IS of the window WM may be formed as a flat plane without bending in a plan view.

Further, operation S1000 of forming the window WM from the preliminary window PWM may include an operation of forming the lower surface PLA of the window WM constituting the flat plane. The lower surface PLA of the window WM may be formed while the etchant LQD etches a portion of the first area EA, which overlaps the opening OP of the upper film DFR. The lower surface PLA of the window WM formed through the etching processes of FIGS. 9A to 9D may form the flat plane.

Operation S1000 of forming the window WM from the preliminary window PWM may include an operation of forming the side surface IS and the lower surface PLA of the window WM so that an angle defined between the side surface IS of the window WM and the lower surface PLA of the window WM is an obtuse angle. The lower surface PLA of the window WM and the side surface IS of the window WM may define an obtuse angle. In an embodiment, an angle defined between the lower surface PLA of the window WM and the side surface next (adjacent) to the first pad PD1 may be an obtuse angle, and an angle defined by the lower surface PLA of the window WM and the side surface next (adjacent) to the second pad PD2 may be an obtuse angle, for example.

Portions of the first pad PD1 and the second pad PD2 of the disclosure may have a circular shape. Further, in the window manufacturing method of the disclosure, as operation S700 of etching the preliminary window PWM and operation S800 of moving the control module CTL in the direction away from the preliminary window PWM are repeatedly performed, an area in which the first pad PD1 and the second pad PD2 are not in contact with the preliminary window PWM may be changed continuously. That is, because the first pad PD1 and the second pad PD2 are not in contact with the preliminary window PWM, the area of the preliminary window PWM may be continuously changed. Thus, each of the side surfaces IS of the window WM formed through the above process may have a single slope. Further, the window WM may be etched inside the etchant LQD to have the flat lower surface PLA. The side surfaces IS and the lower surface PLA of the window WM may have a flat surface without bending. In a cross-section, the side surfaces IS of the window WM may have gentle straight lines with respect to the lower surface PLA. Accordingly, in the electronic device ED (refer to FIG. 1) including the window WM, during light transmission, a constant transmission amount may be maintained, and user's visibility may be improved.

According to the above description, a first pad and a second pad of the disclosure may provide a pressure to a distal end of an upper film and a preliminary window while covering the distal end of the upper film, which defines an opening. With this pressure, a lifting phenomenon occurring at the distal end of the upper film may be reduced or removed.

Portions of the first pad and the second pad of the disclosure may have a circular shape. Further, in the window manufacturing method of the disclosure, an operation of etching the preliminary window and an operation of moving a control module in a direction away from the preliminary window are repeatedly performed, and thus an area in which the first pad and the second pad are not in contact with the preliminary window may be continuously changed. Thus, side surfaces of a window may have a gentle straight line with respect to a lower surface in a cross-section. Accordingly, in an electronic device including the window, during light transmission, a constant transmission amount may be maintained, and user's visibility may be improved.

Although the description has been made above with reference to an embodiment of the disclosure, it may be understood that those skilled in the art or those having ordinary knowledge in the art may variously modify and change the disclosure without departing from the spirit and technical scope of the disclosure described in the appended claims. Thus, the technical scope of the disclosure is not limited to the detailed description of the specification but should be defined by the appended claims.

What is claimed is:

1. A window manufacturing method comprising:
preparing a tank defining a concave groove;
arranging a preliminary window including a first area and a second area next to the first area with the first area interposed therebetween in the concave groove of the tank;
arranging an upper film defining an opening overlapping the first area of the preliminary window on the preliminary window;
preparing a control module including a pad attaching part to which a first pad and a second pad spaced apart from the first pad are coupled;
moving the control module so that the first pad and the second pad are arranged inside the opening of the upper film;
providing an etchant to the concave groove of the tank;
primarily etching the preliminary window non-contacting the first pad and the second pad;
moving the control module in a direction away from the preliminary window so that first portions of the first pad and the second pad are exposed from the opening of the upper film;
secondarily etching the preliminary window non-contacting the first pad and the second pad; and
forming a window from the preliminary window.

2. The window manufacturing method of claim 1, wherein the providing the etchant to the concave groove of the tank includes:
brining the first pad, the second pad, and the pad attaching part into contact with the etchant.

3. The window manufacturing method of claim 1, wherein the moving the control module so that the first pad and the second pad are arranged inside the opening of the upper film includes:
brining the first pad and the second pad into contact with the preliminary window.

4. The window manufacturing method of claim 1, wherein the moving the control module so that the first pad and the second pad are arranged inside the opening of the upper film includes:
moving the control module so that the first pad and the second pad cover a distal end of the upper film, which defines the opening.

5. The window manufacturing method of claim 1, wherein a first side surface of the first pad and a second side surface of the second pad face each other, and a distance between the first side surface and the second side surface is constant or decreased in a thickness direction of the preliminary window.

6. The window manufacturing method of claim 1, wherein the primary etching the preliminary window non-contacting the first pad and the second pad includes:
forming a (1-1)^{th} inner side surface next to the first pad, a (2-1)^{th} inner side surface next to the second pad, and a first lower surface extending to the (1-1)^{th} inner side surface and the (2-1)^{th} inner side surface.

7. The window manufacturing method of claim 6, wherein the secondarily etching the preliminary window non-contacting the first pad and the second pad includes:
forming a (1-2)^{th} inner side surface next to the first pad, a (2-2)^{th} inner side surface next to the second pad, and a second lower surface extending to the (1-2)^{th} inner side surface and the (2-2)^{th} inner side surface.

8. The window manufacturing method of claim 7, wherein a first width which is a maximum distance between the (1-1)^{th} inner side surface and the (2-1)^{th} inner side surface is smaller than a second width which is a maximum distance between the (1-2)^{th} inner side surface and the (2-2)^{th} inner side surface.

9. The window manufacturing method of claim 7, wherein a first depth which is a distance from an upper surface to the first lower surface of the preliminary window is smaller than a second depth which is a distance from the upper surface to the second lower surface of the preliminary window.

10. The window manufacturing method of claim 1, wherein the moving the control module in the direction away from the preliminary window includes:
moving the control module in a direction away from the etchant.

11. The window manufacturing method of claim 1, wherein the moving the control module in the direction away from the preliminary window includes:
alternately repeating a first mode of stopping a movement of the control module and a second mode of moving the control module in the direction away from the preliminary window.

12. The window manufacturing method of claim 1, further comprising, after the secondarily etching the preliminary window:
moving the control module in the direction away from the preliminary window so that second portions of the first pad and the second pad are exposed from the opening of the upper film; and
tertiarily etching the preliminary window non-contacting the first pad and the second pad,
wherein a volume of a second portion of the second portions is greater than a volume of a first portion of the first portions.

13. The window manufacturing method of claim 1, wherein the forming the window from the preliminary window includes:
forming a side surface of the window, which forms one slope with a lower surface of the window.

14. The window manufacturing method of claim 1, wherein the forming the window from the preliminary window includes:
forming a lower surface of the window, which forms a flat plane.

15. The window manufacturing method of claim 1, wherein the forming the window from the preliminary window includes:
forming a side surface and a lower surface of the window so that an angle defined between the side surface of the window and the lower surface of the window is an obtuse angle.

16. A window manufacturing device comprising:
a tank in which an etchant is accommodated and a preliminary window is disposed;
a control module including a first pad and a second pad spaced apart from the first pad;
a horizontal moving part configured to move the control module in a direction parallel to a first direction or a second direction perpendicular to the first direction; and
a vertical moving part configured to move the control module in a direction parallel to a third direction perpendicular to the first direction and the second direction,
wherein a first side surface of the first pad and a second side surface of the second pad face each other, and a distance between the first side surface and the second side surface is constant or decreased in the third direction.

17. The window manufacturing device of claim 16, wherein the vertical moving part includes a first mode of stopping a movement of the control module and a second mode of moving the control module in the third direction, and
wherein the first mode and the second mode are alternately repeated.

18. The window manufacturing device of claim 16, wherein each of the first pad and the second pad includes an elastic material.

19. The window manufacturing device of claim 16, wherein a distance between the first side surface and the second side surface is continuously decreased in the third direction.

20. The window manufacturing device of claim 16, wherein each of the first side surface and the second side surface includes a first pad portion in which a distance between the first side surface and the second side surface is decreased in the third direction and a second pad portion in which the distance between the first side surface and the second side surface is constant in the third direction.
